(19) United States
(12) Patent Application Publication
(10) Pub. No.: US 2009/0190505 A1
(43) Pub. Date: Jul. 30, 2009

(54) Method and apparatus for targeted content delivery based on real-time communication session analysis

(75) Inventors: Mike Gassewitz, Ottawa (CA); Denny Lee, Ottawa (CA); Rob Gaudet, Carp (CA)

Correspondence Address: Kramer & Amado, P.C., 1725 Duke Street, Suite 240, Alexandria, VA, 22314, US

(73) Assignee: ALCATEL LUCENT, Paris (FR)

(21) Appl. No.: 12/010,805

(22) Filed: Jan. 30, 2008

(51) Int. Cl. H04L 12/16

(52) U.S. Cl. 370/259

(57) ABSTRACT

A system and related method for targeted content delivery based on real time communication session analysis, including one or more of the following: a behavior analyzer that formulates a behavioral profile of a user of a terminal device that requests and receives a real time communication; a targeted content delivery infrastructure that establishes behavioral profile data regarding the user and delivers targeted content to the user; and a packet-based communication network in communication with the terminal device, the communication network comparing collected traffic flows to known real time communication protocols, identifying one or more matches between the collected traffic flows and the known real time communication protocols, resulting in one or more identified real time communication sessions, identifying signaling information flow and optionally a bearer channel of the one or more identified real time communication sessions, and extracting key information from the identified signaling information flow and optional bearer channel.

### BACKGROUND OF THE INVENTION

1. Field of the Invention

This invention relates generally to the dissemination of targeted information through communications networks.

2. Description of Related Art

Packetized real-time communication is increasing in popularity. One example is the use of voice over Internet protocol (VoIP) technology for voice service. Such real-time communication also encompasses multi media calls such as a video call, multi-party calls in which there are more than two calling parties, and other session-based communication in collaboration services.

In connection with such systems and methods, it is desirable to be able to monitor and analyze these real-time communication sessions. One benefit of an ability to monitor and analyze packetized real-time communication sessions is delivering targeted content based on a session analysis. Unfortunately, there is not currently an ability to monitor and analyze packetized real-time communication sessions such as those described above.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In current embodiments, real-time communications are handled using circuit-based technology, such as time division multiplexing (TDM). Voice calls are handled and switched through the public switched telephone network (PSTN). In contradistinction, video calls are accomplished by way of an enterprise's own private network, or, to a certain extent, using integrated services digital network (ISDN) based technology.

In current embodiments, call records and call patterns are used for network-level traffic planning purposes, and such information is seldom processed for the purpose of targeted content delivery. An example of targeted content delivery includes personalized advertisements.

With the advent of the Internet and the proliferation of broadband access, more and more session-based real time communications take place over a packetized mechanism. This is especially true over Internet protocol (IP). Such real-time communication services are offered by a variety of publically available service providers, and also by carriers themselves.

In the case of carriers themselves, the real-time communication service is offered to the carrier's subscribers. Accordingly, various exemplary embodiments are implemented by carriers.

Deep packet inspection (DPI) technology has been deployed by carriers to monitor Internet traffic for the purposes of traffic control and engineering. Some current embodiments utilize DPI for the purposes of targeted content delivery. In various exemplary embodiments, the DPI function is extended to monitor and process call-related signaling.

In various exemplary embodiments, the DPI function is extended to monitor and process bearer information. In various exemplary embodiments, the monitored information is in turn used for inferring and formulating a user demographic and/or behavioral profile information of a user.

In light of the present need for a method and apparatus for targeted content delivery based real-time communication session analysis, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

### BRIEF DESCRIPTION OF THE DRAWINGS

In order to better understand various exemplary embodiments, reference is made to the accompanying drawings, wherein:

FIG. 1 is a schematic diagram of a first exemplary embodiment of a system for targeted content delivery based on real-time communication session analysis;

FIG. 2 is a schematic diagram of a second exemplary embodiment of a system for targeted content delivery based on real-time communication session analysis;

FIG. 3 is a schematic diagram of a third exemplary embodiment of a system for targeted content delivery based on real-time communication session analysis; and

FIG. 4 is a flow chart of an exemplary embodiment of a method for targeted content delivery based on real-time communication session analysis:

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

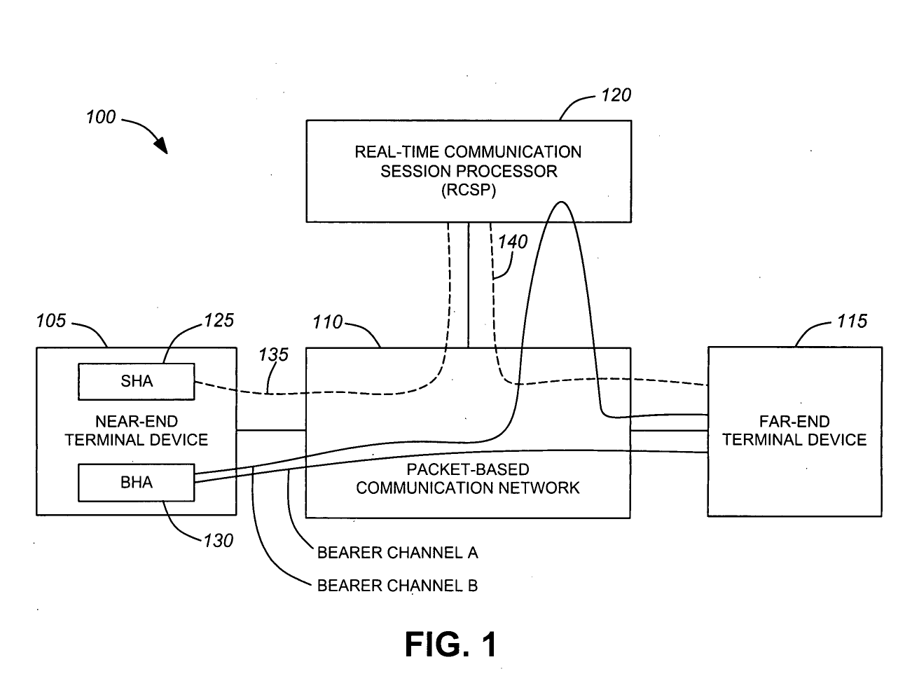

FIG. 1 is a schematic diagram of a first exemplary embodiment of a system 100 for targeted content delivery based on real-time communication session analysis. Exemplary system 100 depicts the basic communication framework in a two party situation. System 100 includes a near-end terminal device 105 in communication with a packet-based communication network 110. The packet-based communication network 110 is in communication with a far-end terminal device 115 and a real-time communication session processor (RCSP) 120.

The near-end terminal device 105 is a customer premise based client computing device that is capable of signaling and handling packet-based real-time communications. For example, the near-end terminal device 105 is a personal computer that is connected to a fixed (wire line) packet network in various exemplary embodiments. Likewise, in various exemplary embodiments, the near-end terminal device 105 is a mobile device such as a cell phone or a personalized data assistant (PDA) that is connected via a wireless packet network.

Accordingly, in various exemplary embodiments, the near-end terminal device 105 is a mobile device connected via a wireless network that either offers mobility or nomadic services. In various exemplary embodiments, the near-end terminal device 105 is a VoIP phone terminal that is connected into the Internet. Accordingly, in various exemplary embodiments, the packet-based communication network 110 is the Internet.

In various exemplary embodiments, the near-end terminal device 105 is a multi media device. Thus, in various exemplary embodiments, the near-end terminal device 105 is able to handle voice calls, video calls, text communications, and so on.

The near-end terminal device includes a signal handling application (SHA) 125 and a bearer handling application (BHA) 130. In various exemplary embodiments, the signal handling application 125 is a software function that handles the signaling and call establishment process in conjunction with the RCSP 120.

Similarly, in various exemplary embodiments, the bearer handling application 130 is a software function that handles a bearer channel of a real-time communication. Accordingly, in various exemplary embodiments, the bearer channel carries voice, video, text, or any other type of digital file in a packetized format.

In various exemplary embodiments, the far-end terminal device 115 is another mobile or fixed terminal device. Accordingly, the various exemplary embodiments described above for the near-end terminal device 105 also apply to the far-end terminal device 115. However, it should be apparent that the type of device in any given system 100 for the far-end terminal device 115 is independent of the type of device for the near-end terminal 105.

The packet-based communication network 110 is a communication network, such as the IP-based Internet, that provides routing of bearer channels such as bearer channel A and/or bearer channel B having packet flow and signaling information packet flow to the appropriate destinations. Accordingly, in various exemplary embodiments, the packet-based communication network 110 is any currently known or later developed communication network capable of transmitting packet-based communications.

The RSCP 120 is a server capable of handling one or more of a variety of functions. These functions include, but are not limited to, authentication, call establishment and tear down, quality of service (QoS) and policy control, directory management, accounting and billing, and any other currently known or later developed control-plane management functions. In various exemplary embodiments, the RCSP 120 is implemented in a physical distributed fashion.

In exemplary system 100, dotted line 135 and dotted line 140 represent signaling information flows. Signaling information flows 135, 140 are information exchanges between the SHA 125 and the RSCP 120 for the purpose of establishing, maintaining and managing real-time communication sessions.

Accordingly, it should be apparent that, though far-end terminal device 115 is not expressly depicted with its own individual signaling handling application or a bearer handling application, it should be understood that, in view of the similarities between the far-end terminal device 115 and the near-end terminal device 105, the far-end terminal device 115 includes an SHA and a BHA in various exemplary embodiments.

In various exemplary embodiments, the signaling information 135, 140 includes one or more of the following: a source address or caller ID; a destination address or caller ID; one or media types; one or more compression/decompression (CODEC) types; a QoS level; a security level; authentication information; location-related information for mobile communications; other subscriber policy related signaling information; and so on.

In various exemplary embodiments, bearer channel A and, alternately, bearer channel B are established to pass media across the packet-based communication network 110. In various exemplary embodiments, bearer channel A and bearer channel B are established once the SHA 125 and RCSP 120 establish a session between the near-end terminal device 105 and the far-end terminal device 115. In various exemplary embodiments, the media passed between the near-end terminal device 105 and the far-end terminal device 115 by way of bearer channel A and/or bearer channel B include voice, video, text, and so on, as discussed elsewhere herein.

Bearer channel B passes through the RCSP 120 whereas bearer channel A is established directly between the near-end terminal device 105 and the far-end terminal device 115 by way of the packet-based communication network 110 without passing through the RCSP 120. Accordingly, bearer channel A represents a peer-to-peer communication. It should be apparent that, as depicted in exemplary system 100, bearer channel A and bearer channel B represent the two primary types of bearer channels available.

In various exemplary embodiments, the communicated media is digitized, compressed, packetized and transported. Accordingly, various exemplary embodiments implement real-time transport protocol (RTP) or real-time streaming protocol (RTSP) over IP for transporting the media stream.

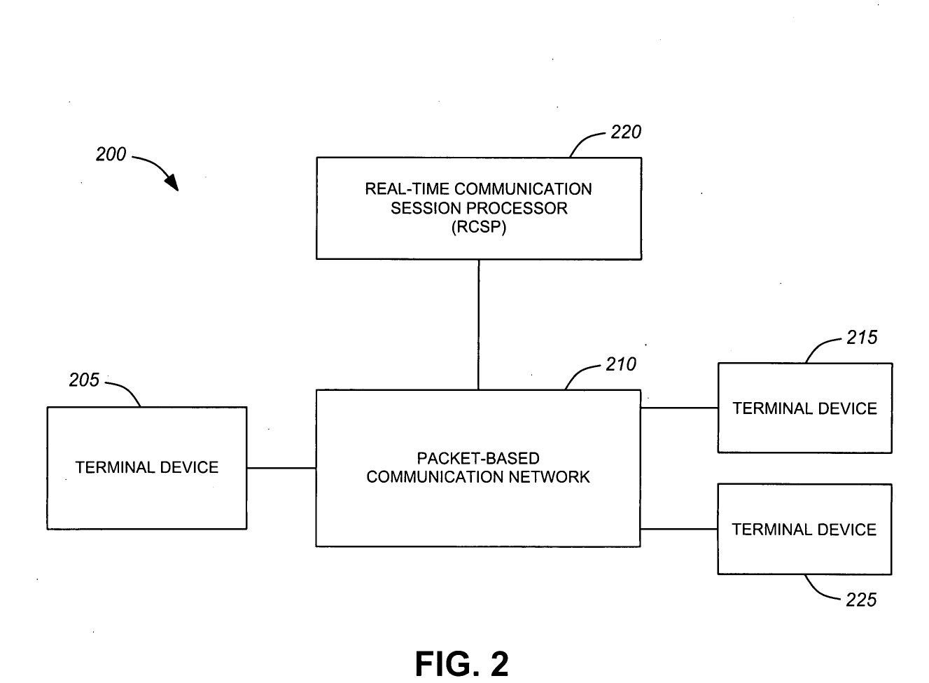

FIG. 2 is a schematic diagram of a second exemplary embodiment of a system 200 for targeted content delivery based on real-time communication session analysis. Exemplary system 200 depicts a multi-party real-time communication situation. Accordingly, there are more than two terminal devices depicted in system 200. In particular, system 200 includes terminal device 205, terminal device 215 and terminal device 225.

It should be understood that, in various exemplary embodiments, each of the terminal devices 205, 215, 225 include an SHA. Likewise, it should be apparent that the SHA in each of terminal devices 205, 215, 225 establishes a communication session via signaling with the RCSP 220 in a manner similar to that described above in connection with exemplary system 100.

Once a communication session is established, a multi-way call can occur between terminal device 205, terminal device 215 and terminal device 225. In various exemplary embodiments, the bearer channel traverses the RCSP 220 such that the bearer channel is duplicated or multicast for all of the receiving parties of the call, in particular, terminal device 205, terminal device 215 and terminal device 225.

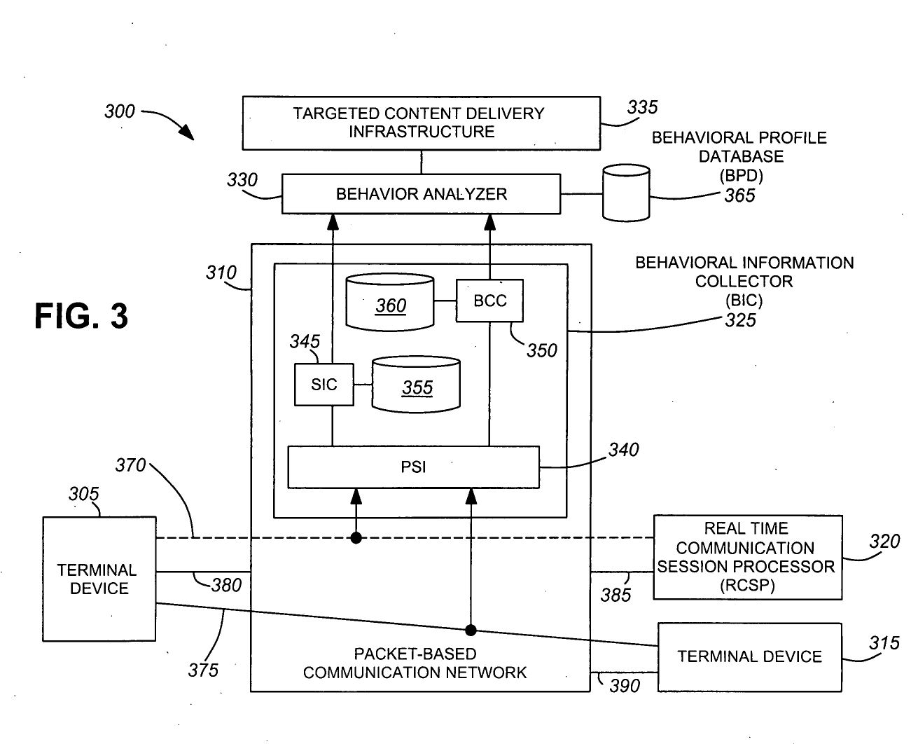

FIG. 3 is a schematic diagram of a third exemplary embodiment of a system 300 for targeted content delivery based on real-time communication session analysis. It should be apparent that, exemplary system 300 implements a communication framework comparable to the communication frameworks described above in connection with exemplary system 100 and/or exemplary system 200. Accordingly, exemplary system 300 includes a terminal device 305, a packet-based communication network 310, a terminal device 315 and an RCSP 320.

The terminal device 305 is in communication with the packet-based communication network 310 by way of communication path 380. The terminal device 315 is in communication with the packet-based communication network 310 by way of communication path 390. The RCSP 320 is in communication with the packet-based communication network by way of communication path 385.

It should be apparent that the communications described herein between the terminal device 305, the terminal device 315, the RCSP 320 and the packet-based communication network 310 take place through communication paths 380, 385, 390. It should also be apparent that comparable communication paths are depicted in connection with exemplary system 100 and exemplary system 200.

The packet-based communication network 310 includes a behavior information collector (BIC) 325. The BIC 325 includes a protocol signature identifier (PSI) 340, a signaling information collector (SIC) 345 including SIC storage 355 and a bearer channel collector (BCC) 350 including BCC storage 360.

The PSI 340 is used to monitor and match in-line traffic flow against a set of known protocol signatures. In this manner, various real-time communication protocols are identified within the in-line traffic flows. The PSI 340 is used to identify the signaling information flow as well as the bearer channel of the real-time communication session. Accordingly, the PSI 340 is used to operate in connection with any currently existing, or later developed, signaling protocols such as session initiation protocol (SIP).

In various exemplary embodiments, after the signaling information flows are identified by the PSI 340, the SIC 345 extracts key information out of the identified signaling information flow. In various exemplary embodiments, the key information extracted by the SIC 345 is stored in SIC storage 355. In various exemplary embodiments, the key information extracted by the SIC 345 corresponds to information described above in connection with signaling information flows 135, 140.

In various exemplary embodiments, once the real-time communication is identified, the bearer channel corresponding thereto is stored by BCC 350 in BCC storage 360. It should be apparent that storing the bearer channel in BCC storage 360 by BCC 350 is an option that does not exist in other exemplary embodiments. Accordingly, in various exemplary embodiments, the BCC 350 is excluded.

In various exemplary embodiments, the information stored in BCC storage 360 includes transport header information such as RTP/RTSP/IP header information. Likewise, in various exemplary embodiments, the information stored by BCC 350 in BCC storage 360 includes bearer channel content.

In various exemplary embodiments, the bearer channel content includes media that is digitized and compressed. In such embodiments, when all appropriate levels of consent such as from a subscriber and/or a content provider, and so on, are obtained, the stored SIC information is used for uncompressing and reversed-digitizing such that the media information is used for further behavioral analysis purposes. Accordingly, in various exemplary embodiments, information is communicated from SIC 345 and/or BCC 350 to behavior analyzer 330.

In various exemplary embodiments, behavior analyzer 330 formulates a user behavior profile based on the collected behavioral information. In various exemplary embodiments, the behavior information includes the data collected from the SIC 345 and BCC 350. In various exemplary embodiments, this information is used to infer, formulate and reinforce a view of a demographic, psychographic and/or relevant-interest profile of a user of the terminal device 305 and/or terminal device 315.

For example, in various exemplary embodiments, a called party location is used to infer a particular interest in a geographical location. In the case where terminal device 305 and/or terminal device 315 are mobile devices, embedded location based information is used to infer a physical area of interest of the user of the terminal device 305 and/or terminal device 315. For example, when a user of the terminal device 305, 315 frequents a particular shopping mall, embedded geographic based location information is used, in various exemplary embodiments, to infer that the user has an interest in that shopping mall.

In various exemplary embodiments, behavior profiles developed by behavioral analyzer 330 are stored in behavioral profile database (BPD) 365. Also, in various exemplary embodiments, system 300 includes targeted content delivery infrastructure 335 as depicted.

In various exemplary embodiments, targeted content delivery infrastructure 335 utilizes user profile data established by behavioral analyzer 330 to deliver highly relevant and personalized content to the users of terminal devices 305, 315. For example, in various exemplary embodiments, targeted content delivery infrastructure 335 matches a most suitable product recommendation or other advertisement against the mentioned demographic, psychographic and other relevant-interest data contained within the behavioral profile database 365 for a given user.

In various exemplary embodiments, the personalized content is delivered via a partner web publisher portal. In various exemplary embodiments, the personalized content is delivered by other targeted means, including, but not limited to, a mobile communication or Internet protocol based video such as Internet protocol television (IPTV).

In various exemplary embodiments, other collected data is used in conjunction with a behavioral profile as described herein. For example, some embodiments use website click stream data in order to formulate a user profile based on a sequence of browsing navigations by a user of the terminal device 305, 315.

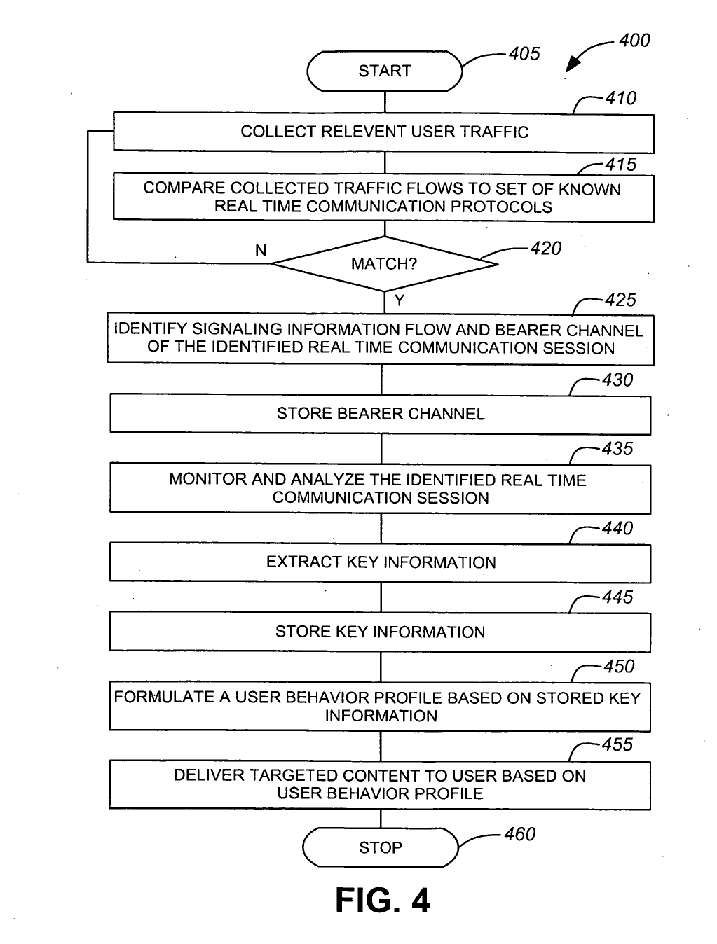

FIG. 4 is a flow chart of an exemplary method 400 for targeted content delivery based on real-time communication session analysis. It should be apparent that the various steps described in connection with exemplary method 400 are performed by the structural elements as described above in connection with exemplary system 100, exemplary system 200 and exemplary system 300.

Exemplary method 400 starts in step 405 and continues to step 410. In step 410 relevant user traffic is collected. Exemplary method 400 then proceeds to step 415.

In step 415, the collected traffic flows are compared to a set of known real-time communication protocols. The method 400 then proceeds to step 420.

In step 420, a determination is made whether a match exists between the collected traffic flows and the set of known real-time communication protocols. When a determination is made in step 420 that no match exists between the collected traffic flows and the set of known real-time communication protocols, the method 400 returns to step 410 where the collection of relevant user traffic continues.

When a determination is made in step 420 that a match does exist between one or more collected traffic flows and one or more members of the set of known real-time communication protocols, the method 400 proceeds to step 425. In step 425, the signaling information flow and bearer channel of the identified real-time communication session are identified. The identified real-time communication session is the real-time communication session for which a match was identified in step 420.

Following step 425, the method 400 proceeds to step 430. In step 430, the bearer channel is stored. In various exemplary embodiments, step 430 is excluded. Next, the method 400 proceeds to step 435.

In step 435, the identified real-time communication session is monitored and analyzed. In embodiments where both channels are being collected, both the signaling channel and the bearer channel are monitored and analyzed in parallel in step 435.

Following step 435, the method 400 proceeds to step 440. In step 440, key information is extracted. Next, the method 400 proceeds to step 445. In step 445, the key information extracted in step 440 is stored. In embodiments where both channels are being collected, the extraction of key information in step 440 and storing of key information in step 445 take place in parallel on both the signaling channel and the bearer channel.

Following step 445, the method 400 proceeds to step 450. In step 450, a user behavioral profile is formulated based on the stored key information. Following step 450, the method 400 proceeds to step 455. In step 455, targeted content is delivered to the user based on the behavioral profile of that user.

Following step 455, the method 400 proceeds to step 460. In step 460, the method 400 stops.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A system for targeted content delivery based on real time communication session analysis, comprising:
a behavior analyzer that formulates a behavioral profile of a user of a terminal device, the user of the terminal device requesting a real time communication session through the terminal device and receiving a requested real time communication at the terminal device;
a targeted content delivery infrastructure that establishes behavioral profile data regarding the user of the terminal device and delivers targeted content to the terminal device of the user; and
a packet-based communication network in communication with the terminal device, the packet-based communication network comparing collected traffic flows to known real time communication protocols, identifying one or more matches between the collected traffic flows and the known real time communication protocols, resulting in one or more identified real time communication sessions, identifying signaling information flow of the one or more identified real time communication sessions, and extracting key information from the identified signaling information flow.

2. The system for targeted content delivery based on real time communication session analysis, according to claim 1, wherein the behavior analyzer formulates the behavioral profile of the user based on the extracted key information.

3. The system for targeted content delivery based on real time communication session analysis, according to claim 1, wherein the packet-based communication network stores the extracted key information.

4. The system for targeted content delivery based on real time communication session analysis, according to claim 1, wherein the packet-based communication network includes a protocol signature identifier that compares the collected traffic flows to known real time communication protocols, identifies the one or more matches between the collected traffic flows and the known real time communication protocols, and identifies the signaling information flow and the bearer channel of the one or more identified real time communication sessions.

5. The system for targeted content delivery based on real time communication session analysis, according to claim 1, wherein the packet-based communication network includes a signaling information collector that extracts the key information.

6. The system for targeted content delivery based on real time communication session analysis, according to claim 5, wherein the signaling information collector includes storage that stores the extracted key information.

7. The system for targeted content delivery based on real time communication session analysis, according to claim 1, wherein the packet-based communication network includes a bearer channel collector with storage that stores the bearer channel of the one or more identified real time communication sessions.

8. The system for targeted content delivery based on real time communication session analysis, according to claim 1, further comprising a behavioral profile database that stores the behavior profile formulated by the behavior analyzer.

9. The system for targeted content delivery based on real time communication session analysis, according to claim 1, wherein the targeted content includes at least one advertisement.

10. The system for targeted content delivery based on real time communication session analysis, according to claim 1, wherein the real time communication includes an audio component.

11. The system for targeted content delivery based on real time communication session analysis, according to claim 1, wherein the real time communication includes a text component.

12. The system for targeted content delivery based on real time communication session analysis, according to claim 1, wherein the real time communication includes one or more still images.

13. The system for targeted content delivery based on real time communication session analysis, according to claim 1, wherein the real time communication includes digital content that is not video.

14. The system for targeted content delivery based on real time communication session analysis, according to claim 1, wherein the real time communication is packetized.

15. The system for targeted content delivery based on real time communication session analysis, according to claim 1, wherein the real time communication includes a video feed.

16. The system for targeted content delivery based on real time communication session analysis, according to claim 1, wherein the terminal device is a wireless communication device and the targeted content is delivered to the user of the terminal device via a wireless communications network.

17. The system for targeted content delivery based on real time communication session analysis, according to claim 16, wherein the terminal device is selected from the list consisting of a mobile telephone and a personal data assistant.

18. The system for targeted content delivery based on real time communication session analysis, according to claim 1, wherein the terminal device is a computer terminal and the targeted content is delivered to the user of the terminal device via the Internet.

19. The system for targeted content delivery based on real time communication session analysis, according to claim 1, wherein the targeted content is delivered to the user via Internet protocol based video.

20. The system for targeted content delivery based on real time communication session analysis, according to claim 1, wherein the real time communication is received at the terminal device from a real time communication session processor.

21. The system for targeted content delivery based on real time communication session analysis, according to claim 1, wherein the real time communication is received at the terminal device from another terminal device.

22. The system for targeted content delivery based on real time communication session analysis, according to claim 1, wherein the behavioral profile of the user includes at least one of a demographic data, a psychographic data, and a relevant interest of the user.

23. The system for targeted content delivery based on real time communication session analysis, according to claim 22, wherein the behavioral profile of the user includes an interest in a particular geographical location.

24. The system for targeted content delivery based on real time communication session analysis, according to claim 1, wherein the packet-based communication network further identifies a bearer channel and extracts key information from the identified bearer channel.

25. A method of delivering targeted content to a user based on real time communication session analysis, comprising:
collecting relevant user traffic;
comparing collected traffic flows to a set of known real time communication protocols;
determining that a match exists between collected traffic flows and one or more members of the set of known real time communication protocols, resulting in one or more identified real time communication sessions;
monitoring and analyzing the one or more identified real time communication sessions;
extracting key information from the one or more identified real time communication sessions;
formulating a user behavior profile based on the key information; and
delivering the targeted content to the user based on the user behavior profile.

26. The method of targeted content delivery based on real time communication session analysis, according to claim 25, further comprising storing the key information.

27. The method of targeted content delivery based on real time communication session analysis, according to claim 25, further comprising identifying a signaling information flow and a bearer channel of the one or more identified real time communication sessions.

28. The method of targeted content delivery based on real time communication session analysis, according to claim 27, further comprising storing the bearer channel.
